(19) United States
(12) Patent Application Publication
(10) Pub. No.: US 2026/0045161 A1
(43) Pub. Date: Feb. 12, 2026

(54) METHOD AND APPARATUS FOR CONSTRUCTING ROAD CONGESTION PREDICTION MODEL, DEVICE, MEDIUM, AND PRODUCT

(71) Applicant: The Hong Kong University of Science and Technology (Guangzhou), Guangzhou (CN)

(72) Inventors: Hui Xiong, Guangzhou (CN); Wenzhao Jiang, Guangzhou (CN); Jindong Han, Guangzhou (CN); Hao Liu, Guangzhou (CN)

(21) Appl. No.: 19/294,362

(22) Filed: Aug. 8, 2025

(30) Foreign Application Priority Data
Aug. 8, 2024 (CN) 202411081936.1

(51) Int. Cl. G08G 1/01; G06F 18/25; G06N 7/01

(52) U.S. Cl. CPC G08G 1/0141; G06F 18/253; G06N 7/01; G08G 1/012; G08G 1/0129

(57) ABSTRACT

Provided are a method and an apparatus for constructing a road congestion prediction model, a device, a medium, and a product. A road traffic network is defined as a directed weighted graph. Historical dynamic traffic features of each road segment in the road traffic network are obtained as sample data, including recent dynamic traffic features and periodic dynamic traffic features. The sample data is input into a mixture of adaptive graph learners (MAGL) model for learning, and a probability prediction vector is output. The sample data is input into a trend expert model, and a trend distribution vector of a predicted probability of future traffic conditions is output. The periodic dynamic traffic features are fused to determine a periodicity prediction vector. An aggregated logit vector is obtained. An objective function is determined based on the aggregated logit vector. Congestion prediction training is performed to obtain a road congestion prediction model.

### CROSS REFERENCE TO RELATED APPLICATION

The present application claims priority to Chinese Patent Application No. 202411081936.1 filed on Aug. 8, 2024, which is incorporated herein by reference in its entirety.

### TECHNICAL FIELD

The present disclosure relates to the technical field of intelligent transportation, and specifically, to a method and an apparatus for constructing a road congestion prediction model, a device, a medium, and a product.

### BACKGROUND

A congestion prediction model is widely used in existing solutions to predict road congestion. However, an existing congestion prediction model uses deep learning modeling and has high spatiotemporal dependencies, resulting in poor interpretability, limitations in handling highly dynamic and heterogeneous urban traffic data, and a lack of an ability to learn a complex pattern and robustness against data noise.

### SUMMARY

To resolve the foregoing problem, the present disclosure provides a method and an apparatus for constructing a road congestion prediction model, a device, a medium, and a product, to improve model interpretability while ensuring congestion prediction accuracy and robustness.

The embodiments of the present disclosure provide a method for constructing a road congestion prediction model. The method includes:
defining a road traffic network as a directed weighted graph, and obtaining historical dynamic traffic features of each road segment in the road traffic network as sample data, where the sample data includes recent dynamic traffic features and periodic dynamic traffic features;
inputting the sample data into a preset mixture of adaptive graph learners (MAGL) model for learning, determining an encoded representation of contextual traffic dynamics of each road segment, and outputting a probability prediction vector;
inputting the recent dynamic traffic features into a preset trend expert model, and outputting a trend distribution vector of a predicted probability of future traffic conditions;
fusing the periodic dynamic traffic features based on a preset periodic expert model to determine a periodicity prediction vector;
performing cascading aggregation on the probability prediction vector, the trend distribution vector, and the periodicity prediction vector to obtain an aggregated logit vector; and
determining an objective function based on the aggregated logit vector, and performing congestion prediction training on the MAGL model, the trend expert model, and the periodic expert model through supervised learning to obtain a road congestion prediction model.

Preferably, the method further includes:
acquiring static road attributes and real-time vehicle track data of a target road network;
extracting dynamic traffic features of each road segment in the target road network based on the static road attributes and the real-time vehicle track data of the target road network;
processing the dynamic traffic features to obtain recent historical dynamic traffic features and periodic historical dynamic traffic features;
inputting the recent historical dynamic traffic features and the periodic historical dynamic traffic features into the road congestion prediction model to obtain a congestion level of each road segment in the target road network in a future period; and
performing travel time estimation, vehicle routing, or traffic scheduling based on the congestion level of each road segment in the future period.

Preferably, the MAGL model includes a plurality of stacked MAGL layers. Each of the MAGL layers includes an upstream expert, a downstream expert, and a global expert. The inputting the sample data into a preset MAGL model for learning, determining an encoded representation of contextual traffic dynamics of each road segment, and outputting a probability prediction vector includes:
extracting a temporal dynamic representation from the sample data based on a preset temporal convolutional network (TCN), and deriving a short-term spatiotemporal context through a lightweight summation operator;
determining gate inputs of each road segment based on the short-term spatiotemporal context, static road attributes of each road segment, a spatial steady-state embedding, and temporal steady-state embeddings;
outputting activation weights of the upstream expert, the downstream expert, and the global expert corresponding to each road segment based on the gate inputs and a sparse gating mechanism of a first multilayer perceptron (MLP);
determining outputs of the upstream expert, the downstream expert, and the global expert corresponding to each road segment based on the recent dynamic traffic features;
aggregating the outputs of the upstream expert, the downstream expert, and the global expert corresponding to each road segment based on the activation weights of the upstream expert, the downstream expert, and the global expert corresponding to each road segment to obtain the encoded representation of the contextual traffic dynamics of each road segment; and
generating the probability prediction vector for a congestion level of each road segment for a preset quantity of subsequent time steps through a second MLP based on the encoded representation of the contextual traffic dynamics of each road segment.

Preferably, the inputting the recent dynamic traffic features into a preset trend expert model, and outputting a trend distribution vector of a predicted probability of future traffic conditions includes:
performing multiscale decomposition on the recent dynamic traffic features through discrete wavelet transform (DWT), and reconstructing a trend signal from a low-frequency component through inverse wavelet transform (IWT); and
analyzing the trend signal by combining the trend expert model constructed based on a multi-head self-attention (MSA) mechanism with an MLP-based output mapping layer, and outputting the trend distribution vector of the predicted probability of the future traffic conditions.

Preferably, the performing cascading aggregation on the probability prediction vector, the trend distribution vector, and the periodicity prediction vector to obtain an aggregated logit vector includes:
determining expert weights of the trend distribution vector and the periodicity prediction vector based on a preset confidence function;
aggregating the trend distribution vector and the probability prediction vector based on the expert weight of the trend distribution vector to obtain a cascading vector; and
aggregating the periodicity prediction vector and the cascading vector based on the expert weight of the periodicity prediction vector to obtain the aggregated logit vector.

Preferably, the determining an objective function based on the aggregated logit vector, and performing congestion prediction training on the MAGL model, the trend expert model, and the periodic expert model through supervised learning to obtain a road congestion prediction model includes:
redistributing part of a probability from a target class to other classes based on a preset ordinal regression loss strategy, adjusting an element of one-hot label encoding, and determining a congestion level label;
calculating a relative entropy between the aggregated logit vector and the congestion level label;
calculating an importance balancing loss and a load balancing loss of each of the plurality of MAGL layers, and determining the objective function based on the importance balancing loss and the load balancing loss of each MAGL layer and the relative entropy; and
performing congestion prediction training on the MAGL model, the trend expert model, and the periodic expert model through supervised learning based on the objective function to obtain the road congestion prediction model.

Further, the objective function is

$$ℒ = {ℒ}_{ord} + {λ}_{1} {\sum }_{l = 1}^{L} {ℒ}_{i m p}^{( l )} + {λ}_{2} {\sum }_{l = 1}^{L} {ℒ}_{load}^{( l )} . \qquad ( 1 )$$

[symbol] is a loss value. [symbol] _{ord} is the relative entropy.

$${ℒ}_{i m p}^{( l )} and {ℒ}_{load}^{( l )}$$

are respectively the importance balancing loss and the load balancing loss of the l^{th} MAGL layer. L is a quantity of MAGL layers. λ₁ and λ₂ are hyperparameters controlling a degree of expert balance.

The embodiments of the present disclosure further provide an apparatus for constructing a road congestion prediction model. The apparatus includes:
a definition module configured to define a road traffic network as a directed weighted graph, and obtain historical dynamic traffic features of each road segment in the road traffic network as sample data, where the sample data includes recent dynamic traffic features and periodic dynamic traffic features;
a mixture module configured to input the sample data into a preset MAGL model for learning, determine an encoded representation of contextual traffic dynamics of each road segment, and output a probability prediction vector;
a trend module configured to input the recent dynamic traffic features into a preset trend expert model, and output a trend distribution vector of a predicted probability of future traffic conditions;
a periodicity module configured to fuse the periodic dynamic traffic features based on a preset periodic expert model to determine a periodicity prediction vector;
a cascading module configured to perform cascading aggregation on the probability prediction vector, the trend distribution vector, and the periodicity prediction vector to obtain an aggregated logit vector; and
a training module configured to determine an objective function based on the aggregated logit vector, and perform congestion prediction training on the MAGL model, the trend expert model, and the periodic expert model through supervised learning to obtain a road congestion prediction model.

Preferably, the apparatus further includes an execution module configured to:
acquire static road attributes and real-time vehicle track data of a target road network;
extract dynamic traffic features of each road segment in the target road network based on the static road attributes and the real-time vehicle track data of the target road network;
process the dynamic traffic features to obtain recent historical dynamic traffic features and periodic historical dynamic traffic features;
input the recent historical dynamic traffic features and the periodic historical dynamic traffic features into the road congestion prediction model to obtain a congestion level of each road segment in the target road network in a future period; and
perform travel time estimation, vehicle routing, or traffic scheduling based on the congestion level of each road segment in the future period.

The embodiments of the present disclosure further provide a terminal device, including a processor, a memory, and a computer program stored in the memory and configured to be executed by the processor. The processor executes the computer program to implement the method for constructing a road congestion prediction model according to any one of the foregoing embodiments.

The embodiments of the present disclosure further provide a non-transitory computer-readable storage medium. The non-transitory computer-readable storage medium includes a stored computer program. When the computer program is run, a device in which the non-transitory computer-readable storage medium is located is controlled to perform the method for constructing a road congestion prediction model according to any one of the foregoing embodiments.

The embodiments of the present disclosure further provide a computer program product, including a non-transitory computer-readable storage medium that includes computer-readable program code. The computer-readable program code is executable to enable a computer to implement the method for constructing a road congestion prediction model according to any one of the foregoing embodiments.

The present disclosure provides the method and apparatus for constructing a road congestion prediction model, device, medium, and product. The road traffic network is defined as the directed weighted graph. The historical dynamic traffic features of each road segment in the road traffic network are obtained as the sample data. The sample data includes the recent dynamic traffic features and the periodic dynamic traffic features. The sample data is input into the preset MAGL model for learning, the encoded representation of the contextual traffic dynamics of each road segment is determined, and the probability prediction vector is output. The recent dynamic traffic features are input into the preset trend expert model, and the trend distribution vector of the predicted probability of the future traffic conditions is output. The periodic dynamic traffic features are fused based on the preset periodic expert model to determine the periodicity prediction vector. Cascading aggregation is performed on the probability prediction vector, the trend distribution vector, and the periodicity prediction vector to obtain the aggregated logit vector. The objective function is determined based on the aggregated logit vector. Congestion prediction training is performed on the MAGL model, the trend expert model, and the periodic expert model through supervised learning to obtain the road congestion prediction model. The solutions of the present application improve model interpretability while ensuring congestion prediction accuracy and robustness.

### BRIEF DESCRIPTION OF THE DRAWINGS

FIG. 1 is a schematic flowchart of a method for constructing a road congestion prediction model according to an embodiment of the present disclosure;

FIG. 2 is a schematic structural diagram of a road congestion prediction model according to an embodiment of the present disclosure;

FIG. 3 is a schematic structural diagram of a MAGL layer according to an embodiment of the present disclosure;

FIG. 4 is a schematic structural diagram of an apparatus for constructing a road congestion prediction model according to an embodiment of the present disclosure;

FIG. 5 is a schematic structural diagram of an apparatus for constructing a road congestion prediction model according to an embodiment of the present disclosure; and

FIG. 6 is a schematic structural diagram of a terminal device according to an embodiment of the present disclosure.

### DETAILED DESCRIPTION

The technical solutions in the embodiments of the present disclosure are described clearly and completely below with reference to the accompanying drawings in the embodiments of the present disclosure. Apparently, the described embodiments are merely some rather than all of the embodiments of the present disclosure. All other embodiments obtained by those of ordinary skill in the art based on the embodiments of the present disclosure without creative efforts shall fall within the protection scope of the present disclosure.

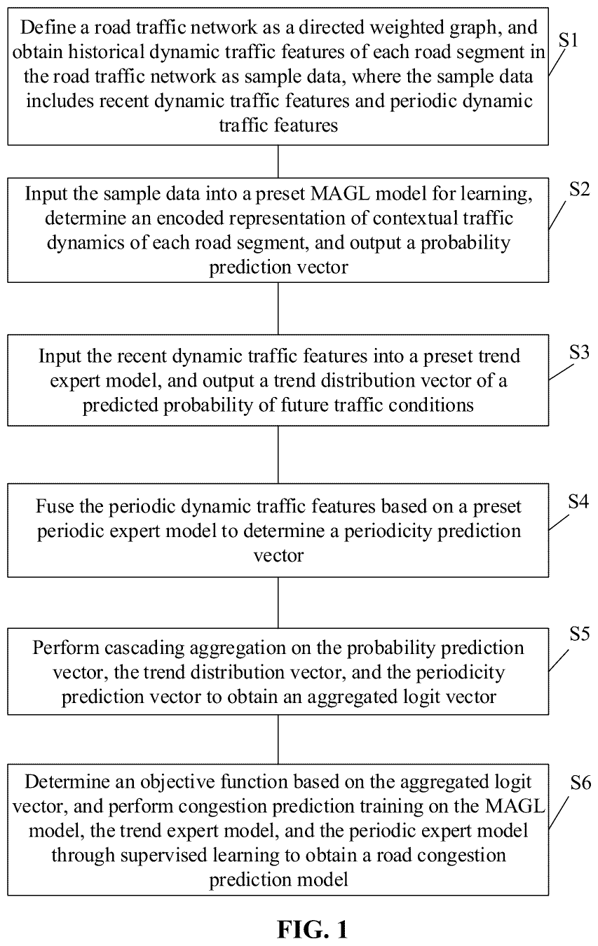

FIG. 1 is a schematic flowchart of a method for constructing a road congestion prediction model according to an embodiment of the present disclosure. The method includes steps S1 to S6.

S1: Define a road traffic network as a directed weighted graph, and obtain historical dynamic traffic features of each road segment in the road traffic network as sample data. The sample data includes recent dynamic traffic features and periodic dynamic traffic features.

S2: Input the sample data into a preset MAGL model for learning, determine an encoded representation of contextual traffic dynamics of each road segment, and output a probability prediction vector.

S3: Input the recent dynamic traffic features into a preset trend expert model, and output a trend distribution vector of a predicted probability of future traffic conditions.

S4: Fuse the periodic dynamic traffic features based on a preset periodic expert model to determine a periodicity prediction vector.

S5: Perform cascading aggregation on the probability prediction vector, the trend distribution vector, and the periodicity prediction vector to obtain an aggregated logit vector.

S6: Determine an objective function based on the aggregated logit vector, and perform congestion prediction training on the MAGL model, the trend expert model, and the periodic expert model through supervised learning to obtain a road congestion prediction model.

During specific implementation of this embodiment, the traffic network is defined first to construct the directed weighted graph of the network. That is, the road traffic network is defined as a directed weighted graph [symbol] =(V, E).

vᵢ ∈ V represents a road segment. V represents a road segment set. E represents an edge set of the directed weighted graph, which is specifically a set formed by adjacency relationships between the road segments. eᵢⱼ ∈ E represents the adjacency relationship between the road segments vᵢ and vⱼ. At a time step t, dynamic traffic features are expressed as X^{t} ∈ R^{N×C} N=|V| represents a quantity of road segments. C represents a quantity of dynamic traffic feature types. Traffic features include an average vehicle speed, road conditions, and the like, and are referred to as “dynamic traffic features” because they dynamically change over time. In addition,

$${X}_{i}^{t} ∈ {R}^{C}$$

represents the dynamic traffic features of the road segment vᵢ at the time step t.

Congestion degrees are defined through three discrete congestion levels to evaluate traffic conditions of road segments: smooth, slow, and congested, which are denoted as classes 0, 1, and 2, respectively.

Based on the foregoing concepts, an objective problem, namely congestion prediction, is defined: Given a traffic feature sequence X^{t-T}^{ₚ}^{+1:t}:=(X^{t-T}^{ₚ}⁺¹, X^{t-T}^{ₚ}⁺², . . . , X^{t}) ∈ R^{T}^{ₚ}^{×N×C} in previous Tₚ time steps as the recent dynamic traffic features, the periodic dynamic traffic features [symbol] , and the directed weighted graph [symbol] of the road traffic network, an objective is to learn a mapping function F(·) to predict a congestion level in future T_{f} time steps:

$$ℱ : ( {X}^{t - {T}_{p} + 1 : t} , ℋ ; 𝒢 ) ↦ {\hat{Y}}^{t + 1 : t + {T}_{f}} ∈ {\{ 0 , 1 , 2 \}}^{{T}_{f} \times N} .$$

Ŷ^{t+1:t+T}^{_{f}} represents the predicted congestion level of each road segment in the future T_{f} time steps.

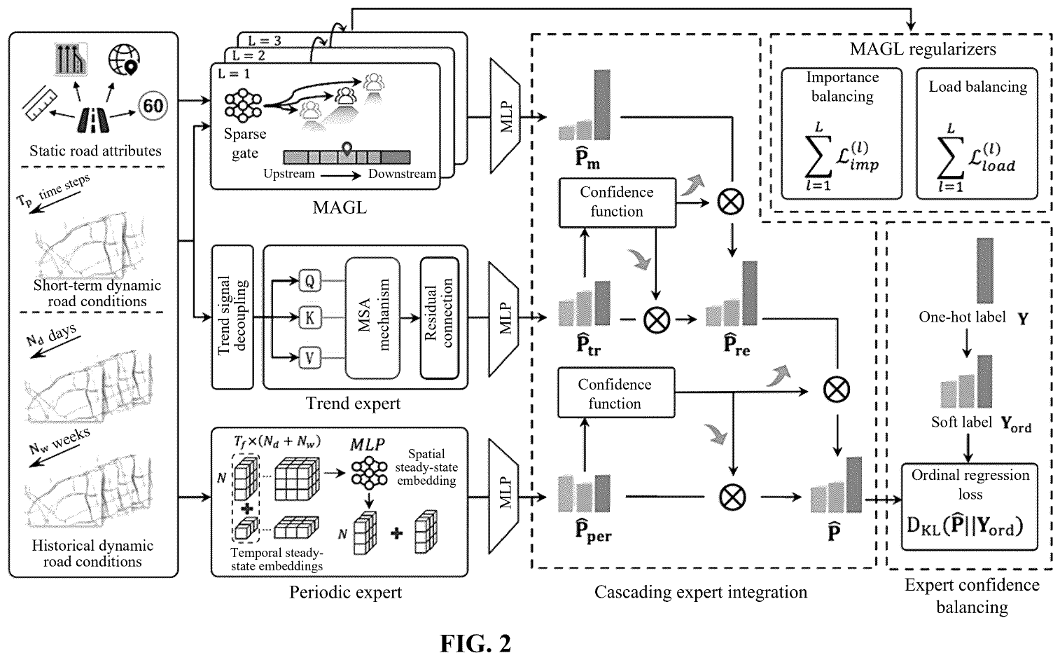

FIG. 2 is a schematic structural diagram of a road congestion prediction model according to an embodiment of the present disclosure. An overall framework of the congestion prediction model proposed by the present application includes three major modules:

MAGL model: This module includes a plurality of MAGL layers constructed based on a sparsely gated mixture of experts (MoE) architecture. These layers selectively route samples to specialized graph learning experts to comprehensively and effectively explore spatiotemporal dependencies. The sample data is input into the preset MAGL model for learning, the encoded representation of the contextual traffic dynamics of each road segment is determined, and the probability prediction vector is output.

Cascading integration of trend and periodic experts: This module adaptively integrates two specialized experts to capture trend and periodic patterns, enhancing the model's robustness to handle corrupted data. The recent dynamic traffic features are input into the preset trend expert model, and the trend distribution vector of the predicted probability of the future traffic conditions is output. The trend expert model is constructed based on a self-attention neural network.

The periodic dynamic traffic features are fused based on the preset periodic expert model to determine the periodicity prediction vector. The periodic expert model is constructed based on an MLP.

Expert confidence balancing: This module uses ordinal regression to guide experts in recognizing ordinal relationships between congestion levels, mitigating overconfidence in their predictions and fostering effective expert collaboration. Specifically, static road attributes and a dynamic historical road condition observation sequence of each road segment are input into the MAGL model, trend expert model, and periodic expert model to perform targeted modeling of a road condition evolution pattern and obtain probabilities predicted by the three models for road conditions of these road segments in a plurality of future time steps.

Cascading aggregation is performed on the predicted probabilities through a learnable confidence function to obtain an overall probability prediction result of the model. Cascading aggregation is performed on the probability prediction vector, the trend distribution vector, and the periodicity prediction vector to obtain the aggregated logit vector.

Supervised learning is performed on the prediction result and a softened true road condition label, and an expert balancing regularizer is introduced, to ensure that each modeling expert of the model can learn unique abilities and is not overconfident. In this way, expert cooperation is promoted to obtain an accurate road condition prediction result. The objective function is determined based on the aggregated logit vector, and congestion prediction training is performed through supervised learning to obtain the road congestion prediction model.

In the customized MoE-based congestion prediction model of the present disclosure, introducing a congestion-aware inductive bias enables different experts to focus on processing different fine-grained road condition evolution patterns, and improves congestion prediction accuracy. Stable trend and periodic signals are fully utilized. Experts specializing in trend and periodic signal modeling are separately designed. These stable temporal signals are modeled to improve robustness while maintaining congestion prediction accuracy.

Expert aggregation based on prediction confidences makes an expert cooperation process transparent such that a user understands an inherent mechanism of the model in congestion prediction, to implement interpretable congestion prediction.

In the congestion prediction model provided by the present disclosure, designing customized road condition modeling experts and promoting beneficial cooperation between the experts can effectively improve congestion prediction accuracy, robustness, and interpretability, to empower construction of an intelligent transportation system.

In another embodiment provided by the present disclosure, the MAGL model includes a plurality of stacked MAGL layers. Each of the MAGL layers includes an upstream expert, a downstream expert, and a global expert. Step S2 specifically includes:
extracting a temporal dynamic representation from the sample data based on a preset TCN, and deriving a short-term spatiotemporal context through a lightweight summation operator;
determining gate inputs of each road segment based on the short-term spatiotemporal context, static road attributes of each road segment, a spatial steady-state embedding, and temporal steady-state embeddings;
outputting activation weights of the upstream expert, the downstream expert, and the global expert corresponding to each road segment based on the gate inputs and a sparse gating mechanism of a first MLP;
determining outputs of the upstream expert, the downstream expert, and the global expert corresponding to each road segment based on the recent dynamic traffic features;
aggregating the outputs of the upstream expert, the downstream expert, and the global expert corresponding to each road segment based on the activation weights of the upstream expert, the downstream expert, and the global expert corresponding to each road segment to obtain the encoded representation of the contextual traffic dynamics of each road segment; and
generating the probability prediction vector for a congestion level of each road segment for a preset quantity of subsequent time steps through a second MLP based on the encoded representation of the contextual traffic dynamics of each road segment.

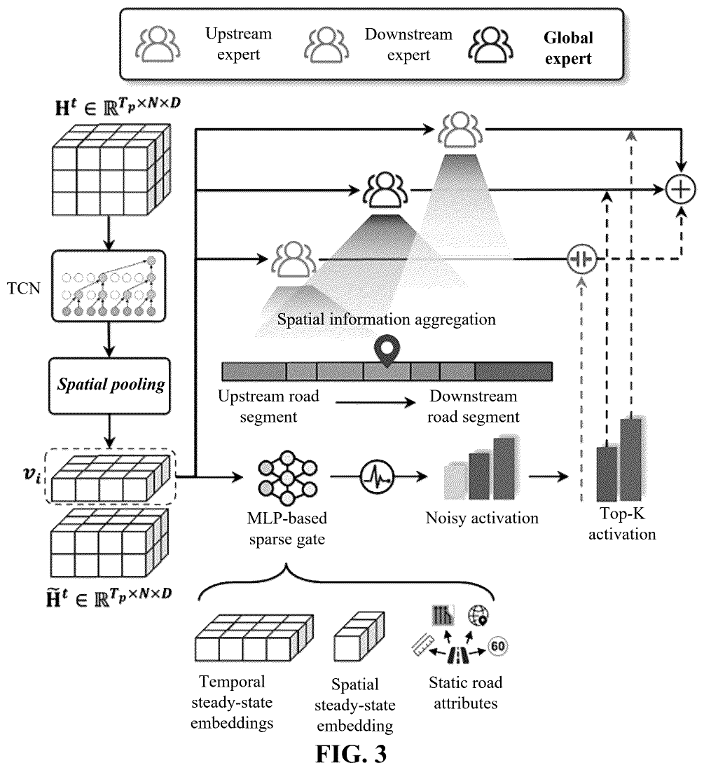

During specific implementation of this embodiment, FIG. 3 is a schematic structural diagram of a MAGL layer according to an embodiment of the present disclosure.

An ideal sparse gating function should route an input road segment to a most suitable expert for spatiotemporal modeling under specific context conditions. To achieve this goal, fine-grained context features are selected as gate inputs to enhance distinguishability of road segment samples. Since a convolutional network is sensitive to a high-frequency signal (for example, unexpected congestion), the recent dynamic traffic features of the road segment vᵢ at the time step t are first encoded to obtain

$${H}_{i}^{t} . {H}_{i}^{t}$$

is an encoded representation of the recent dynamic traffic features of the road segment vᵢ at the time step t. Next,

$${H}_{i}^{t}$$

is input into the TCN, and a temporal dynamic representation

$${H}_{i}^{{t}^{′}}$$

is output. Similarly, a temporal dynamic representation

$${H}_{j}^{{t}^{′}}$$

may be obtained based on the recent dynamic traffic features of the road segment vⱼ at the time step t and the TCN. Then, a short-term spatiotemporal context

$${\tilde{H}}_{i}^{t} = {\sum }_{{v}_{j} ∈ {N}_{i}^{k}} {H}_{j}^{{t}^{′}}$$

is derived through the lightweight summation operator.

$${N}_{i}^{k}$$

represents a k-hop neighbor of the road segment vᵢ.

$${\tilde{H}}_{i}^{t}$$

represents summing temporal dynamic representations corresponding to all k-hop neighbors of the road segment vᵢ.

Considering that short-term road condition information may still lack distinguishability in different scenarios, three types of steady-state features are further incorporated: (1) static road attributes S; (2) a trainable spatial steady-state embedding Eₛ ∈ R^{N×D}^{ₗ} for encoding unique steady-state attributes of a road segment, where D1 is a hyperparameter and is manually specified; and (3) trainable temporal steady-state embeddings E^{ToD} ∈ R^{288×D}^{ₗ} and E^{DoW} ∈ R^{7×D}ₗ for encoding regular temporal steady-state patterns. In general, the gate input of the road segment vᵢ at the time step t is

$${c}_{i}^{t} {=}^{△} I ( {H}_{i}^{t} ) = {\tilde{H}}_{i}^{t} ‖ {MLP}_{s} ( {S}_{i} ) ‖ {E}_{i}^{s} ‖ {E}_{t}^{T o D} ‖ {E}_{t}^{D o W} .$$

MLPs(·) represents a learnable MLP. Sᵢ represents static road attributes of the road segment vᵢ, including a length, quantity of lanes, speed limit class, and the like.

$${E}_{i}^{s}$$

represents a spatial steady-state embedding of the road segment vᵢ. ToD represents time-of-day, and DoW represents day-of-week.

$${E}_{t}^{T o D} and {E}_{t}^{D o W}$$

represent temporal steady-state embeddings.

$${E}_{t}^{T o D}$$

corresponds to a relative position of the time step t on a current day.

$${E}_{t}^{DoW}$$

corresponds to a relative position of the time step t in a current week.

∥ represents a vector concatenation operation. The gating function generates the activation weight of the corresponding expert based on the gate input:

$$G ( {c}_{i}^{t} ) = Softmax ( TopK ( {MLP}_{g} ( {c}_{i}^{t} ) + ϵ \cdot Softplus ( {MLP}_{n} ( {c}_{i}^{t} ) ) ) ) .$$

Softplus(·) is an activation function. MLP_{g}(·) is a learnable MLP. Gaussian noise ϵ˜N(0,1) is added to the expert's activation weight output by MLP_{g}(·), to avoid over-reliance of the model on a few specific experts. TopK(·) retains largest K entries in the weights. MLPₙ(·) is a learnable MLP and is independent of MLP_{g}(·).

In congestion-aware graph learning experts, there is a significant difference in spatiotemporal patterns between traffic congestion and non-congestion scenarios. The pattern difference may introduce noise and even conflicting knowledge, making it difficult to train a unified model that perfectly recognizes traffic patterns in different scenarios. To address this challenge, three groups of graph learning experts are designed, each having a dedicated inductive bias to specialize in a specific pattern type.

Specifically, traffic congestion usually propagates from downstream to upstream road segments, whereas traffic freely flows from upstream to downstream road segments during non-congestion periods. Based on this characteristic, two specialized expert groups, namely the upstream expert and the downstream expert, are configured to simulate these two distinct propagation dynamics. The upstream expert and the downstream expert are constructed based on an edge-aware graph attention network.

In general, each expert E(·) is constructed based on an edge-aware graph attention network, and adaptively aggregates neighbor road segment information to update a representation of each road segment:

$$E ( {H}_{i}^{t} ) = {\sum }_{j ∈ {N}_{i}} {α}_{i j} {W}_{j} {H}_{j}^{t} + {H}_{i}^{t} ,$$

namely the output of the upstream expert, the downstream expert, or the global expert. W represents a j^{th} row of a learnable mapping matrix W.

$${H}_{j}^{t}$$

is an encoded representation of the recent dynamic traffic features of the road segment vⱼ at the time step t.

The weight αᵢⱼ is calculated through the following formula, reflecting importance of information aggregation between nodes (namely the road segments):

$${α}_{i j} = \frac{exp ( L e a kyReLU ( {a}^{T} [ W {H}_{i}^{t} ‖ {WH}_{j}^{t} ‖ {W}_{r} {r}_{ij} ] ) )}{{\sum }_{k ∈ {𝒩}_{i}} exp ( L e a kyReLU ( {a}^{T} [ W {H}_{i}^{t} ‖ {WH}_{k}^{t} ‖ {W}_{r} {r}_{ik} ] ) )}$$

W, Wᵣ, and a^{T} represent learnable mapping matrices. For the upstream expert, [symbol] includes all upstream road segments of the road segment vᵢ. For the downstream expert, [symbol] covers only downstream road segments of the road segment vᵢ. LeakyReLU(·) is an activation function. rᵢⱼ represents a weight of an edge between the road segments vᵢ and vⱼ. rᵢₖ represents a weight of an edge between the road segments vᵢ and vₖ.

However, a graph topology constructed based on a road network is often noisy and incomplete, which may not reflect an actual relationship between road segments. A group of global experts is additionally assigned to specialize in identifying latent propagation patterns. Each global expert is constructed based on an edge-aware graph attention network. Each global expert is equipped with a unique learnable road segment embedding Eₛ ∈ R^{N×D1} for encoding inherent spatial characteristics. A latent dependency between the road segments vᵢ and vⱼ may be inferred through the weight:

$${α}_{i j} = Softmax ( ReLU ( {E}_{i}^{s} {E}_{j}^{{s}^{T}} ) ) . ReLU ( \cdot )$$

is an activation function.

$${E}_{j}^{s}$$

represents a spatial steady-state embedding of the road segment vⱼ.

Information aggregation is performed based on the dependency such that the global expert can capture the implicit propagation pattern beyond the road network adjacency relationship, to enhance an ability of the model to understand and predict complex traffic dynamics.

Each MAGL layer utilizes a learnable sparse gating mechanism to select a few specific experts for a specific road segment to perform modeling at each observation moment, and aggregates the outputs of the experts based on the weights routed to the experts, to finally obtain the encoded representation of the contextual traffic dynamics of each road segment. Formally, the MAGL layer is defined as follows:

$${H}_{i}^{t ( l + 1 )} = {\sum }_{n = 1}^{{N}_{e}} {G}_{n} ( I ( {H}_{i}^{{t}^{( l )}} ) ) \cdot {E}_{n} ( {H}_{i}^{{t}^{( l )}} )$$

Nₑ represents a quantity of experts. G(·) represents a sparse gating function. Gₙ(·) is an n^{th} element of an output vector from G(·), used to determine importance of the n^{th} expert Eₙ(·). I(·) is a function specially designed for enriching gate inputs.

$${H}_{i}^{{t}^{( l )}} ∈ {R}^{{T}_{p} \times D}$$

is an output of an I^{th} layer for the road segment vᵢ at the time step t.

$${H}_{i}^{{t}^{( 0 )}} = FC ( {X}_{i}^{t - {T}_{p} + 1 : t} ) .$$

FC(·) represents a fully connected layer.

In practice, L MAGL layers are stacked, and the probability prediction vector

$${P}_{m}^{t + 1 : t + {T}_{f}} = M L {P}_{m} ( {H}_{i}^{{t}^{( l )}} )$$

is generated through an MLP for the congestion level of each road segment over next T_{f} time steps.

$${H}_{i}^{{t}^{( L )}}$$

represents outputs of all layers for the road segment vᵢ at the time step t. Similarly, corresponding processing is performed for all road segments to obtain probability prediction vectors for all road segments.

In another embodiment provided by the present disclosure, step S3 specifically includes:
performing multiscale decomposition on the recent dynamic traffic features through DWT, and reconstructing a trend signal from a low-frequency component through IWT; and
analyzing the trend signal by combining the trend expert model constructed based on an MSA mechanism with an MLP-based output mapping layer, and outputting the trend distribution vector of the predicted probability of the future traffic conditions.

During specific implementation of this embodiment, although the MAGL can model diversified traffic propagation patterns, road condition prediction accuracy is affected if short-term historical road condition data is contaminated. In such contexts, modeling trend and periodic signals is particularly important for accurate prediction because they are insensitive to external interference. Inspired by this, model robustness is improved by constructing the trend expert and the periodic expert to capture a stable trend and periodicity, respectively. In addition, the MAGL is of great significance for fully capturing complex non-stationary and irregular patterns in traffic situations. Therefore, it is necessary to organically combine the trend expert, periodic expert, and MAGL to implement accurate and robust road condition prediction. A cascading expert integration technology is designed based on this motivation.

During trend signal decoupling and modeling, a trend in traffic conditions may be represented by low-frequency signals in the recent dynamic traffic features. These signals are often coupled with high-frequency signals that fluctuate over time. Therefore, first, multiscale decomposition is performed on an input sequence X^{t+T}^{ₚ}^{-1:t} through DWT, and a trend signal R^{t+T}^{ₚ}^{-1:t} is reconstructed from the low-frequency component through IWT. Then, the trend expert based on the MSA mechanism is combined with the MLP-based output mapping layer to output the trend distribution vector

$${\hat{P}}_{tr}^{t + 1 : t + {T}_{f}} = M L {P}_{tr} ( M S A ( {R}^{t + {T}_{p} - 1 : t} ) )$$

of the predicted probability of the future traffic conditions. MSA(·) represents the MSA mechanism.

During periodic signal modeling, a periodic pattern contained in historical data can facilitate more robust prediction if a severe error or missingness exists in short-term data. The periodic dynamic traffic features [symbol] contain a global periodic pattern driven by daily travel habits (such as morning commutes) and local periodic features affected by external factors such as recent weather changes. To capture such multi-dimensional periodicity, an efficient MLP-based periodic expert model is designed for future prediction. The periodic dynamic traffic features and learnable spatiotemporal embeddings are fused to determine the periodicity prediction vector

$${\hat{P}}_{per}^{t + 1 : t + {T}_{f}} = M L {P}_{per} ( ℋ , {E}^{s} , {E}^{T o D} , {E}^{D o W} ) .$$

MLPₚₑᵣ(·) represents an MLP. [symbol] represents the periodic dynamic traffic features. E^{ToD} and E^{DoW} represent trainable temporal steady-state embeddings. E^{s} represents a learnable road segment embedding. T_{f} represents T_{f} time steps after the time step t.

Learning the periodic pattern in the historical data can improve prediction stability and accuracy even in the face of heavy data contamination.

In another embodiment provided by the present disclosure, step S5 specifically includes:
determining expert weights of the trend distribution vector and the periodicity prediction vector based on a preset confidence function;
aggregating the trend distribution vector and the probability prediction vector based on the expert weight of the trend distribution vector to obtain a cascading vector; and
aggregating the periodicity prediction vector and the cascading vector based on the expert weight of the periodicity prediction vector to obtain the aggregated logit vector.

During specific implementation of this embodiment, cascading integration of the trend expert model and the periodic expert model ensures that these experts play a leading role in processing corrupted data, while enabling the MAGL to dominate complex pattern capture in the face of irregular traffic situations. However, a distribution similarity between the two types of data makes it particularly difficult to learn an ideal routing strategy without an explicit supervision signal. This issue is mitigated by determining the experts' influence on final prediction through their prediction confidences in the present disclosure.

Specifically, a learnable confidence function is designed to assign a weight to each expert based on an output probability distribution P of the trend expert or the periodic expert: C(\hat{P})=MLP_{c} (D(\hat{P})). D(·) is a dispersion function for calculating a variance and negentropy of the probability distribution to measure a prediction confidence. MLP_{c}(·) is trained to map dispersion to an expert weight within a range of [0,1]. For brevity, a time index superscript of the probability distribution is omitted herein.

An expert aggregation order follows two principles: (1) If all weaker experts have low confidence levels, only stronger experts are activated to focus on learning complex patterns. (2) The periodic expert is considered weaker than the trend expert due to its inaccessibility to latest traffic observation data. These principles lead to a cascading expert aggregation strategy. Accordingly, a final probability distribution of road condition prediction by the congestion prediction model designed in the present disclosure is obtained through cascading integration of outputs of different experts. That is, the trend distribution vector and the probability prediction vector are aggregated based on the expert weight of the trend distribution vector to obtain the cascading vector \hat{P}ᵣₑ=C₂(\hat{P}ₜᵣ)\hat{P}ₜᵣ+(1−C₂(\hat{P}ₜᵣ)) \hat{P}ₘ. \hat{P}ₜᵣ represents a probability distribution vector of the trend expert, namely the trend distribution vector. \hat{P}ₘ represents a probability distribution vector of the MAGL, namely the probability prediction vector.

The periodicity prediction vector and the cascading vector are aggregated based on the expert weight of the periodicity prediction vector to obtain the aggregated logit vector \hat{P}=C₁(\hat{P}ₚₑᵣ)\hat{P}ₚₑᵣ+(1−C₁(\hat{P}ₚₑᵣ)) \hat{P}ᵣₑ.

C₁(·) and C₂(·) are two learnable confidence functions, which are respectively used to evaluate the prediction confidences of the trend expert and the periodic expert and assign corresponding weights.

It should be noted that this method also achieves high interpretability because a model decision process can be explained by the weights of the experts. A contribution (the weight) of each expert intuitively reflects the model's trust tendency in a specific situation: If the short-term data has poor quality, the model may rely more on stable patterns of the trend and periodic experts. In the face of complex and variable non-periodic traffic patterns, a role of the MAGL module may be enhanced. This design not only improves prediction accuracy and robustness, but also makes the model's internal logic more transparent for easy understanding and debugging.

In another embodiment provided by the present disclosure, step S6 specifically includes:
redistributing part of a probability from a target class to other classes based on a preset ordinal regression loss strategy, adjusting an element of one-hot label encoding, and determining a congestion level label;
calculating a relative entropy between the aggregated logit vector and the congestion level label;
calculating an importance balancing loss and a load balancing loss of each of the plurality of MAGL layers, and determining the objective function based on the importance balancing loss and the load balancing loss of each MAGL layer and the relative entropy; and
performing congestion prediction training on the MAGL model, the trend expert model, and the periodic expert model through supervised learning based on the objective function to obtain the road congestion prediction model.

During specific implementation of this embodiment, in an ordinal regression technology for an expert confidence balancing problem, diversified inductive biases in architectures of different experts as well as different degrees of congestion class imbalance within their assigned data subsets may lead to significant confidence differences. Consequently, overconfident experts may undermine contributions of other experts, causing the cascading expert integration module to make biased predictions. To address this challenge, an expert overconfidence issue is mitigated through an ordinal regression strategy in the present disclosure. This method smooths a one-hot label into a soft label by redistributing part of the probability from the target class to other classes, to reduce the experts' over-certainty about a single class.

In addition, a class closer to the target class is assigned a higher probability to maintain natural ordering among classes. This strategy further enriches each class in label space through information from nearby classes, effectively reducing overconfidence caused by class imbalance.

Specifically, an i^{th} element of the one-hot label encoding is adjusted to y_{ord} [i]e^{-ϕ(i,y)}/Σⱼ e^{-ϕ(j,y)}. y represents the target class, namely a target congestion level. ϕ(·,·) is a predefined distance metric function for penalizing a probability of a class away from the target class. In the context of congestion prediction, given a limited quantity of classes, ϕ(·) may be determined through hyperparameter tuning.

In practice, the distance metric function is further constrained to satisfy ϕ(i, j)+ϕ(j, k)=ϕ(i, k), where 0≤i≤j≤k, to narrow a tuning range to a set of parameters {ϕ(i, i+1)}_{i≥0}.

An overall optimization objective is determined. An optimization objective with two parts is designed to train the road congestion prediction model designed in the present disclosure. The first part is an ordinal regression loss, aiming to promote balanced confidences among experts. The loss is implemented by calculating a Kullback-Leibler (KL) divergence between a logit probability P output by a congestion prediction MoE (CP-MoE) model (namely the road congestion prediction model) and an ordinally smoothed congestion level label Y_{ord}: [symbol] _{ord}=D_{KL}(\hat{P} ∥Y_{ord}). [symbol] _{ord} is the relative entropy.

The second part includes two types of expert balancing regularizers, aiming to prevent model collapse in the MAGL module. Specifically, each MAGL layer is equipped with an importance balancing loss [symbol] ᵢₘₚ to limit a variation in weights assigned to different graph experts, and a load balancing loss [symbol] _{load} to ensure equitable activation frequencies of the experts.

Congestion prediction training is performed on the MAGL model, the trend expert model, and the periodic expert model through supervised learning based on the objective function to obtain the road congestion prediction model.

In another embodiment provided by the present disclosure, the objective function is

$$ℒ = {ℒ}_{ord} + {λ}_{1} {\sum }_{l = 1}^{L} {ℒ}_{i m p}^{( l )} + {λ}_{2} {\sum }_{l = 1}^{L} {ℒ}_{load}^{( l )} .$$

[symbol] is a loss value. [symbol] _{ord} is the relative entropy.

$${ℒ}_{i m p}^{( l )} and {ℒ}_{1 o a d}^{( l )}$$

are respectively the importance balancing loss and the load balancing loss of the I^{th} MAGL layer. L is a quantity of MAGL layers. λ₁ and λ₂ are hyperparameters controlling a degree of expert balance.

During specific implementation of this embodiment, the congestion prediction model is trained by jointly optimizing the foregoing objective. The objective function is

$$ℒ = {ℒ}_{ord} + {λ}_{1} {\sum }_{l = 1}^{L} {ℒ}_{i m p}^{( l )} + {λ}_{2} {\sum }_{l = 1}^{L} {ℒ}_{load}^{( l )} .$$

[symbol] is the loss value. [symbol] ₒᵣd is the relative entropy.

$${ℒ}_{i m p}^{( l )} and {ℒ}_{load}^{( l )}$$

are respectively the importance balancing loss and the load balancing loss of the I^{th} MAGL layer. [symbol] ᵢₘₚ=CV( [symbol] Gₙ(x)), [symbol] _{load}=CV( [symbol] Prₙ). L is the quantity of MAGL layers. λ₁ and λ₂ are the hyperparameters controlling the degree of expert balance. CV(·) represents a coefficient of variation. B represents a set of samples in a batch. Gₙ(x) represents a weight assigned to the n^{th} expert for sample data x, which is output by the gating function. Prₙ represents a probability assigned to the n^{th} expert for the sample data x.

In the present disclosure, through a congestion-aware MAGL, this model architecture can fully and efficiently capture diverse and dynamic road condition evolution patterns, which is a basis for high-accuracy congestion prediction. Through cascading expert integration, cascading aggregation with the MAGL as well as modeling stable traffic signals by assigning the trend expert and the periodic expert can improve model robustness and interpretability while ensuring congestion prediction accuracy. This is a key to improving congestion prediction reliability. Considering that overconfident experts dominate an expert aggregation process and further affect a final prediction result, this technical solution provides an optimization strategy based on ordinal regression as well as an expert balancing regularization strategy. This is an important guarantee that the MAGL and the cascading expert integration technology can fully exert their effectiveness.

Compared with the prior art, the present disclosure improves model interpretability while ensuring congestion prediction accuracy and robustness.

Further, based on the method for constructing a road congestion prediction model, the embodiments of the present disclosure further provide a method for predicting traffic conditions. The method for predicting traffic conditions includes:
acquiring static road attributes and real-time vehicle track data of a target road network;
extracting dynamic traffic features of each road segment in the target road network based on the static road attributes and the real-time vehicle track data of the target road network;
processing the dynamic traffic features to obtain recent historical dynamic traffic features and periodic historical dynamic traffic features; and
inputting the recent historical dynamic traffic features and the periodic historical dynamic traffic features into the road congestion prediction model to obtain a congestion level of each road segment in the target road network in a future period.

In an optional embodiment, the method for predicting traffic conditions further includes:
performing travel time estimation based on the congestion level of each road segment in the target road network in the future period.

An estimated travel time is output to a display, and a user can improve travel time estimation accuracy based on the travel time displayed on the display. For example, when using ride-hailing software, the user can obtain an accurate travel time through the travel time estimation, to improve accuracy of the ride-hailing software.

In an optional embodiment, the method for predicting traffic conditions further includes:
performing vehicle routing based on the congestion level of each road segment in the target road network in the future period.

For example, road segments whose congestion levels in the future period are smooth are selected to form a target route of a vehicle, and the target route is output to a display of the vehicle. A driver controls the vehicle to travel based on the target route, to allow for travel on a smooth route while avoiding aggravating congestion.

In an optional embodiment, the method for predicting traffic conditions further includes:
performing traffic scheduling based on the congestion level of each road segment in the target road network in the future period.

For example, for a road segment whose congestion level in the future period is slow or congested, a control signal of a traffic light of the road segment is adjusted to alleviate slow or congested traffic.

During specific implementation, the method for predicting traffic conditions includes:
1. Obtain data: Acquire static road attributes and real-time vehicle track data of a target urban road network, and extract dynamic traffic features (such as a real-time speed and historical congestion level) of each road segment.
2. Process the data: Perform missing value completion on the dynamic traffic features of each road segment, and aggregate the features at a granularity of 5 min to form required inputs of the model, including recent historical dynamic traffic features and periodic historical dynamic traffic features.
3. Perform model inference: Input the recent historical dynamic traffic features and the periodic historical dynamic traffic features into the road congestion prediction model, and output a prediction result, namely a congestion level (such as smooth, slow, or congested) of each road segment in a future period.
4. Apply the result: Use the prediction result for a downstream task, such as travel time estimation, vehicle routing, or intelligent scheduling, to enable a prediction or decision model of the downstream task to predict a future traffic situation.

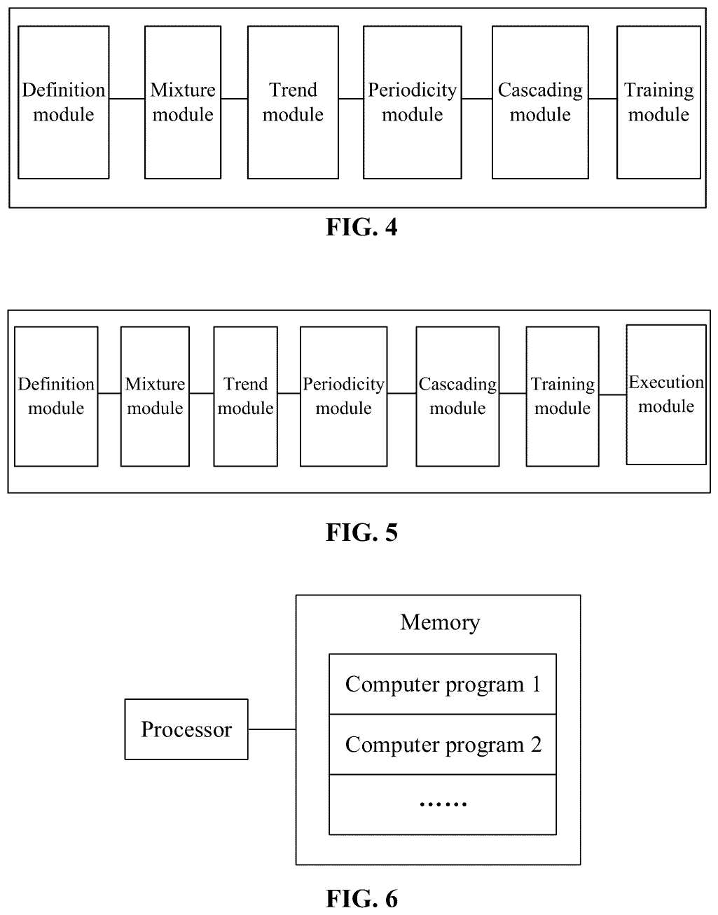

In another embodiment provided by the present disclosure, FIG. 4 is a schematic structural diagram of an apparatus for constructing a road congestion prediction model according to an embodiment of the present disclosure. The apparatus includes:
a definition module configured to define a road traffic network as a directed weighted graph, and obtain historical dynamic traffic features of each road segment in the road traffic network as sample data;
a mixture module configured to input the sample data into a preset MAGL model for learning, determine an encoded representation of contextual traffic dynamics of each road segment, and output a probability prediction vector;
a trend module configured to input recent dynamic traffic features into a preset trend expert model, and output a trend distribution vector of a predicted probability of future traffic conditions;
a periodicity module configured to fuse the obtained historical dynamic traffic features based on a preset periodic expert model to determine a periodicity prediction vector;
a cascading module configured to perform cascading aggregation on the probability prediction vector, the trend distribution vector, and the periodicity prediction vector to obtain an aggregated logit vector; and
a training module configured to determine an objective function based on the aggregated logit vector, and perform congestion prediction training on the MAGL model, the trend expert model, and the periodic expert model through supervised learning to obtain a road congestion prediction model.

FIG. 5 is a schematic structural diagram of an apparatus for constructing a road congestion prediction model according to an embodiment of the present disclosure. The apparatus further includes an execution module configured to:
acquire static road attributes and real-time vehicle track data of a target road network;
extract dynamic traffic features of each road segment in the target road network based on the static road attributes and the real-time vehicle track data of the target road network;
process the dynamic traffic features to obtain recent historical dynamic traffic features and periodic historical dynamic traffic features;
input the recent historical dynamic traffic features and the periodic historical dynamic traffic features into the road congestion prediction model to obtain a congestion level of each road segment in the target road network in a future period; and
perform travel time estimation, vehicle routing, or traffic scheduling based on the congestion level of each road segment in the future period.

The apparatus for constructing a road congestion prediction model provided in this embodiment can perform all steps and functions of the method for constructing a road congestion prediction model provided in any one of the foregoing embodiments. Specific functions of the apparatus are not described herein.

In the embodiments of the present application, the definition module, the mixture module, the trend module, the periodicity module, the cascading module, the training module, and the execution module each may be one or more processors, controllers, or chips that each have a communication interface and can implement a communication protocol, and may further include a memory, a related interface, a system transmission bus, and the like if necessary. The processor, controller, or chip executes program-related code to implement a corresponding function. In an alternative solution, the definition module, the mixture module, the trend module, the periodicity module, the cascading module, the training module, and the execution module share an integrated chip or share devices such as a processor, a controller, and a memory. The shared processor, controller, or chip executes program-related code to implement a corresponding function.

FIG. 6 is a schematic structural diagram of a terminal device according to an embodiment of the present disclosure. The terminal device includes a processor, a memory, and a computer program stored in the memory and executable by the processor, such as a program for constructing a road congestion prediction model. The processor executes the computer program to implement steps in the foregoing embodiments of the method for constructing a road congestion prediction model, for example, steps S1 to S6 shown in FIG. 1. Alternatively, the processor executes the computer program to implement functions of the modules in the foregoing apparatus embodiment.

For example, the computer program may be divided into one or more modules. The one or more modules are stored in the memory and executed by the processor to complete the present disclosure. The one or more modules may be a series of computer program instruction segments capable of implementing specific functions. The instruction segments are used for describing an execution process of the computer program in the terminal device. For example, the computer program may be divided into various modules. Specific functions of the modules have been described in detail in the method for constructing a road congestion prediction model provided in any one of the foregoing embodiments. Specific functions of the terminal device are not described herein.

The terminal device may be a computing device such as a desktop computer, a notebook computer, a palmtop computer, or a cloud server. The terminal device may include, but not limited to, the processor and the memory. Those skilled in the art can understand that the schematic diagram shows merely an example of the terminal device, does not constitute a limitation to the terminal device, and may include more or less components than that shown in the figure, a combination of some components, or different components. For example, the terminal device may further include input and output devices, network access devices, buses, and the like.

The processor may be a central processing unit (CPU), or may be another general-purpose processor, a digital signal processor (DSP), an application-specific integrated circuit (ASIC), a field-programmable gate array (FPGA) or another programmable logic device, a discrete gate, a transistor logic device, a discrete hardware component, or the like. The general-purpose processor may be a microprocessor, or any conventional processor. The processor is a control center of the terminal device, and various parts of the whole terminal device are connected through various interfaces and lines.

The memory may be configured to store the computer program and/or modules. The processor implements various functions of the terminal device by running or executing the computer program and/or modules stored in the memory and invoking data stored in the memory.

The memory may mainly include a program storage area and a data storage area. The program storage area may store an operating system, an application program required by at least one function (such as a sound playing function and an image playing function), and the like. The data storage area may store data (such as audio data and an address book) created based on use of a mobile phone, and the like. In addition, the memory may include a high-speed random access memory, and may further include a non-volatile memory, such as a hard disk, an internal storage, a removable hard disk, a smart media card (SMC), a secure digital (SD) card, a flash card, at least one magnetic disk storage device, a flash memory device, or another volatile solid-state storage device.

The module integrated in the terminal device, if implemented in a form of a software functional unit and sold or used as a stand-alone product, may be stored in a computer-readable storage medium. Based on such an understanding, all or some of processes for implementing the methods in the foregoing embodiments of the present disclosure may be completed by a computer program instructing relevant hardware. The computer program may be stored in a computer-readable storage medium. When the computer program is executed by the processor, the steps in the foregoing method embodiments may be implemented. The computer program includes computer program code. The computer program code may be in a form of source code, in a form of object code, an executable file, in some intermediate forms, or the like. The computer-readable medium may include any physical entity or apparatus capable of carrying the computer program code, a recording medium, a universal serial bus (USB) disk, a removable hard disk, a magnetic disk, an optical disc, a computer memory, a read-only memory (ROM), a random access memory (RAM), an electrical carrier signal, a telecommunications signal, a software distribution medium, or the like.

The embodiments of the present disclosure further provide a non-transitory computer-readable storage medium. The non-transitory computer-readable storage medium includes a stored computer program. When the computer program is run, a device in which the non-transitory computer-readable storage medium is located is controlled to perform the method for constructing a road congestion prediction model in any one of the foregoing embodiments.

The embodiments of the present disclosure further provide a computer program product, including a non-transitory computer-readable storage medium that includes computer-readable program code. The computer-readable program code is executable to enable a computer to implement the method for constructing a road congestion prediction model in any one of the foregoing embodiments.

It should be noted that those of ordinary skill in the art may further make several improvements and modifications without departing from the principle of the present disclosure, but such improvements and modifications should be deemed as falling within the protection scope of the present disclosure.

1. A method for constructing a road congestion prediction model, comprising:
defining a road traffic network as a directed weighted graph, and obtaining historical dynamic traffic features of each road segment in the road traffic network as sample data, wherein the sample data comprises recent dynamic traffic features and periodic dynamic traffic features;
inputting the sample data into a preset mixture of adaptive graph learners (MAGL) model for learning, determining an encoded representation of contextual traffic dynamics of each road segment, and outputting a probability prediction vector;
inputting the recent dynamic traffic features into a preset trend expert model, and outputting a trend distribution vector of a predicted probability of future traffic conditions;
fusing the periodic dynamic traffic features based on a preset periodic expert model to determine a periodicity prediction vector;
performing cascading aggregation on the probability prediction vector, the trend distribution vector, and the periodicity prediction vector to obtain an aggregated logit vector; and
determining an objective function based on the aggregated logit vector, and performing congestion prediction training on the MAGL model, the trend expert model, and the periodic expert model through supervised learning to obtain a road congestion prediction model.

2. The method for constructing a road congestion prediction model according to claim 1, further comprising:
acquiring static road attributes and real-time vehicle track data of a target road network;
extracting dynamic traffic features of each road segment in the target road network based on the static road attributes and the real-time vehicle track data of the target road network;
processing the dynamic traffic features to obtain recent historical dynamic traffic features and periodic historical dynamic traffic features;
inputting the recent historical dynamic traffic features and the periodic historical dynamic traffic features into the road congestion prediction model to obtain a congestion level of each road segment in the target road network in a future period; and
performing travel time estimation, vehicle routing, or traffic scheduling based on the congestion level of each road segment in the future period.

3. The method for constructing a road congestion prediction model according to claim 1, wherein the MAGL model comprises a plurality of stacked MAGL layers, and each of the MAGL layers comprises an upstream expert, a downstream expert, and a global expert; and the inputting the sample data into a preset MAGL model for learning, determining an encoded representation of contextual traffic dynamics of each road segment, and outputting a probability prediction vector comprises:
extracting a temporal dynamic representation from the sample data based on a preset temporal convolutional network (TCN), and deriving a short-term spatiotemporal context through a lightweight summation operator;
determining gate inputs of each road segment based on the short-term spatiotemporal context, static road attributes of each road segment, a spatial steady-state embedding, and temporal steady-state embeddings;
outputting activation weights of the upstream expert, the downstream expert, and the global expert corresponding to each road segment based on the gate inputs and a sparse gating mechanism of a first multilayer perceptron (MLP);
determining outputs of the upstream expert, the downstream expert, and the global expert corresponding to each road segment based on the recent dynamic traffic features;
aggregating the outputs of the upstream expert, the downstream expert, and the global expert corresponding to each road segment based on the activation weights of the upstream expert, the downstream expert, and the global expert corresponding to each road segment to obtain the encoded representation of the contextual traffic dynamics of each road segment; and
generating the probability prediction vector for a congestion level of each road segment for a preset quantity of subsequent time steps through a second MLP based on the encoded representation of the contextual traffic dynamics of each road segment.

4. The method for constructing a road congestion prediction model according to claim 1, wherein the inputting the recent dynamic traffic features into a preset trend expert model, and outputting a trend distribution vector of a predicted probability of future traffic conditions comprises:
performing multiscale decomposition on the recent dynamic traffic features through discrete wavelet transform (DWT), and reconstructing a trend signal from a low-frequency component through inverse wavelet transform (IWT); and
analyzing the trend signal by combining the trend expert model constructed based on a multi-head self-attention (MSA) mechanism with an MLP-based output mapping layer, and outputting the trend distribution vector of the predicted probability of the future traffic conditions.

5. The method for constructing a road congestion prediction model according to claim 1, wherein the performing cascading aggregation on the probability prediction vector, the trend distribution vector, and the periodicity prediction vector to obtain an aggregated logit vector comprises:
determining expert weights of the trend distribution vector and the periodicity prediction vector based on a preset confidence function;
aggregating the trend distribution vector and the probability prediction vector based on the expert weight of the trend distribution vector to obtain a cascading vector; and
aggregating the periodicity prediction vector and the cascading vector based on the expert weight of the periodicity prediction vector to obtain the aggregated logit vector.

6. The method for constructing a road congestion prediction model according to claim 3, wherein the determining an objective function based on the aggregated logit vector, performing congestion prediction training on the MAGL model, the trend expert model, and the periodic expert model through supervised learning to obtain a road congestion prediction model comprises:
redistributing part of a probability from a target class to other classes based on a preset ordinal regression loss strategy, adjusting an element of one-hot label encoding, and determining a congestion level label;
calculating a relative entropy between the aggregated logit vector and the congestion level label;
calculating an importance balancing loss and a load balancing loss of each of the plurality of MAGL layers, and determining the objective function based on the importance balancing loss and the load balancing loss of each MAGL layer and the relative entropy; and
performing congestion prediction training on the MAGL model, the trend expert model, and the periodic expert model through supervised learning based on the objective function to obtain the road congestion prediction model.

7. The method for constructing a road congestion prediction model according to claim 6, wherein the objective function is
$$ℒ = {ℒ}_{ord} + {λ}_{1} {\sum }_{l = 1}^{L} {ℒ}_{i m p}^{( l )} + {λ}_{2} {\sum }_{l = 1}^{L} {ℒ}_{load}^{( l )} ;$$
wherein [symbol]
is a loss value, [symbol] _{ord} is the relative entropy,
$${ℒ}_{i m p}^{( l )} and {ℒ}_{load}^{( l )}$$
are respectively the importance balancing loss and the load balancing loss of the I^{th} MAGL layer, L is a quantity of MAGL layers, and λ₁ and λ₂ are hyperparameters controlling a degree of expert balance.

8. An apparatus for constructing a road congestion prediction model, comprising:
a definition module configured to define a road traffic network as a directed weighted graph, and obtain historical dynamic traffic features of each road segment in the road traffic network as sample data, wherein the sample data comprises recent dynamic traffic features and periodic dynamic traffic features;
a mixture module configured to input the sample data into a preset mixture of adaptive graph learners (MAGL) model for learning, determine an encoded representation of contextual traffic dynamics of each road segment, and output a probability prediction vector;
a trend module configured to input the recent dynamic traffic features into a preset trend expert model, and output a trend distribution vector of a predicted probability of future traffic conditions;
a periodicity module configured to fuse the periodic dynamic traffic features based on a preset periodic expert model to determine a periodicity prediction vector;
a cascading module configured to perform cascading aggregation on the probability prediction vector, the trend distribution vector, and the periodicity prediction vector to obtain an aggregated logit vector; and
a training module configured to determine an objective function based on the aggregated logit vector, and perform congestion prediction training on the MAGL model, the trend expert model, and the periodic expert model through supervised learning to obtain a road congestion prediction model.

9. The apparatus for constructing a road congestion prediction model according to claim 8, further comprising an execution module configured to:
acquire static road attributes and real-time vehicle track data of a target road network;
extract dynamic traffic features of each road segment in the target road network based on the static road attributes and the real-time vehicle track data of the target road network;
process the dynamic traffic features to obtain recent historical dynamic traffic features and periodic historical dynamic traffic features;
input the recent historical dynamic traffic features and the periodic historical dynamic traffic features into the road congestion prediction model to obtain a congestion level of each road segment in the target road network in a future period; and
perform travel time estimation, vehicle routing, or traffic scheduling based on the congestion level of each road segment in the future period.

10. A terminal device, comprising a processor, a memory, and a computer program stored in the memory and configured to be executed by the processor, wherein the processor executes the computer program to implement the method for constructing a road congestion prediction model according to claim 1.

11. A terminal device, comprising a processor, a memory, and a computer program stored in the memory and configured to be executed by the processor, wherein the processor executes the computer program to implement the method for constructing a road congestion prediction model according to claim 2.

12. A terminal device, comprising a processor, a memory, and a computer program stored in the memory and configured to be executed by the processor, wherein the processor executes the computer program to implement the method for constructing a road congestion prediction model according to claim 3.

13. A terminal device, comprising a processor, a memory, and a computer program stored in the memory and configured to be executed by the processor, wherein the processor executes the computer program to implement the method for constructing a road congestion prediction model according to claim 4.

14. A terminal device, comprising a processor, a memory, and a computer program stored in the memory and configured to be executed by the processor, wherein the processor executes the computer program to implement the method for constructing a road congestion prediction model according to claim 5.

15. A terminal device, comprising a processor, a memory, and a computer program stored in the memory and configured to be executed by the processor, wherein the processor executes the computer program to implement the method for constructing a road congestion prediction model according to claim 6.

16. A terminal device, comprising a processor, a memory, and a computer program stored in the memory and configured to be executed by the processor, wherein the processor executes the computer program to implement the method for constructing a road congestion prediction model according to claim 7.

17. A non-transitory computer-readable storage medium, wherein the non-transitory computer-readable storage medium comprises a stored computer program, and when being run, the computer program controls a device in which the non-transitory computer-readable storage medium is located to execute the method for constructing a road congestion prediction model according to claim 1.

18. A non-transitory computer-readable storage medium, wherein the non-transitory computer-readable storage medium comprises a stored computer program, and when being run, the computer program controls a device in which the non-transitory computer-readable storage medium is located to execute the method for constructing a road congestion prediction model according to claim 2.

19. A non-transitory computer-readable storage medium, wherein the non-transitory computer-readable storage medium comprises a stored computer program, and when being run, the computer program controls a device in which the non-transitory computer-readable storage medium is located to execute the method for constructing a road congestion prediction model according to claim 3.

20. A computer program product, comprising a non-transitory computer-readable storage medium that comprises a computer-readable program code, wherein the computer-readable program code is executable to enable a computer to implement the method for constructing a road congestion prediction model according to claim 1.
